(19) United States
(12) Patent Application Publication
(10) Pub. No.: US 2020/0313527 A1
(43) Pub. Date: Oct. 1, 2020

(54) ROTOR OF HYBRID INDUCTION MOTOR AND MOTOR EMPLOYING THE SAME

(71) Applicant: KOREA ELECTRONICS TECHNOLOGY INSTITUTE, Seongnam-si (KR)

(72) Inventors: Raeeun KIM, Seoul (KR); Sehyun RHYU, Bucheon-si (KR); Jungmoo SEO, Goyang-si (KR)

(21) Appl. No.: 16/787,496

(22) Filed: Feb. 11, 2020

(30) Foreign Application Priority Data
Mar. 27, 2019 (KR) 10-2019-0034983

(51) Int. Cl. H02K 17/18

(52) U.S. Cl. CPC H02K 17/185

(57) ABSTRACT

Provided is a rotor suitable for a hybrid induction motor, in which a conducting bar having high conductivity is inserted into the rotor. The rotor includes: a rotation shaft; a rotor core having a through hole formed axially and having a plurality of slots formed to penetrate the rotor core and arranged radially to be symmetric about the through hole; a first conducting bars each being inserted into the slot, being disposed to be in close contact with an inner wall of the slot in a direction of the through hole, and having a protrusion protruding from the rotor core when being inserted into the slot; a fastening member arranged to enclose protrusions of the first conducting bars to fix the plurality of first conducting bars; and second conducting bars, each being disposed in respective one of the slots into which corresponding one of the first conducting bars is inserted.

### CROSS-REFERENCE TO RELATED APPLICATIONS

The present application claims priority to Korean Patent Application No. 10-2019-0034983, filed on Mar. 27, 2019, in the Korean Intellectual Property Office, which is incorporated herein in its entirety by reference.

### TECHNICAL FIELD

The present disclosure relates to a motor and, more particularly, to a rotor of a hybrid induction motor rotor in which a conducting bar having high conductivity is inserted into the rotor for improving an efficiency of the motor. Also, the present disclosure relates to a motor employing the rotor.

### BACKGROUND

A motor is a machine designed to convert electrical energy into mechanical energy to generate a torque and is widely being used at homes and in industries. The motor can be classified broadly into an alternating current (AC) motor and a direct current (DC) motor.

Among the AC motors, an induction motor produces the torque by using a magnetic field electromagnetically induced to a rotor from stator windings and a magnetic field induced by a magnet installed in the rotor. The rotor starts to rotate and operates by the torque produced by an interaction of a secondary current generated by a voltage induced in a conducting bar of the rotor and a magnetic flux generated by the windings of the stator.

Since a rotational efficiency of the rotor can be increased by a magnetic flux generated according to a structure of the stator as well as an induced current flowing in the conducting bar of the rotor, lots of research and development activities have been carried out on the structure for the conducting bar to increase the rotational efficiency of the induction motor.

For example, Korean laying-open patent publication No. 10-2006-0094811 published on Aug. 30, 2006 and entitled ROTOR OF INDUCTION MOTOR AND MANUFACTURING METHOD THEREOF is an evidence of this.

The rotor of an induction motor disclosed in this document includes a rotor core and a conducting bar. The rotor core is formed by laminating a plurality of steel sheets and formed with a plurality of outer slots extending in an axial direction and penetrating the rotor core and a plurality of inner slots each being connected to respective one of the plurality of outer slots. The conducting bar includes an outer conductor disposed in the outer slot and a inner conductor disposed in the inner slot and made of metallic material having higher conductivity than the outer conductor.

The rotor of the induction motor disclosed in the document can simplify a manufacturing process of the motor and improve a productivity while preventing an efficiency degradation through the use of the outer conductor and the inner conductor.

However, the disclosed motor structure may be disadvantageous in that the inner conductor may migrate up, down, left, or right, while the outer conductor is die cast, and thus the metallic material cannot fill the entire slot sufficiently and empty spaces such as bubbles may be introduced in the outer conductor so that the outer conductor may be incomplete, which adversely affect the performance of the motor.

A jig may be used to prevent the migration of the conducting bar, but the use of the jig may make a manufacturing process more complicated, increase a manufacturing cost, and lower the productivity of the motor.

### SUMMARY

Provided are a rotor for use in a hybrid induction motor which allows an application of a plurality of conducting bars of different materials to the rotor stably to improve an efficiency of the hybrid induction motor, and a motor which employs the rotor.

Additional aspects will be set forth in part in the description which follows and, in part, will be apparent from the description, or may be learned by practice of the presented exemplary embodiments.

According to an aspect of an exemplary embodiment, a rotor of a hybrid induction motor includes: a rotation shaft; a rotor core having a through hole formed along a central axis and having a plurality of slots formed to penetrate the rotor core between a top surface and a bottom surface and arranged radially to be symmetric about the central axis; a plurality of first conducting bars, each being inserted into respective one of the plurality of slots, being disposed to be in close contact with an inner wall of the slot in a direction of the through hole, and having a protrusion that may protrude outwards from the rotor core when being inserted into the slot; a fastening member arranged to enclose protrusions of the plurality of first conducting bars to fix the plurality of first conducting bars; and a plurality of second conducting bars, each being disposed in respective one of the plurality of slots into which corresponding one of the plurality of first conducting bars is inserted.

The fastening member may have a shape of a ring or a wire.

The protrusion may have a fastener receiving recess formed on its outer surface.

The fastening member may be inserted into the fastener receiving recess to fix the plurality of first conducting bars.

The plurality of second conducting bars may be formed through a die casting in remaining spaces of the plurality of slots after the plurality of first conducting bars are inserted.

The protrusion may include: a first protrusion protruding upwards from the rotor core; and a second protrusion protruding downwards from the rotor core.

The second protrusion may be provided in a pair and may be fixed to be close to a top surface or a bottom surface the rotor core by an external force.

According to another aspect of an exemplary embodiment, a hybrid induction motor includes: a rotor; and a stator disposed to be spaced apart from the rotor by a predetermined distance. The rotor includes: a rotation shaft; a rotor core having a through hole formed along a central axis and having a plurality of slots formed to penetrate the rotor core between a top surface and a bottom surface and arranged radially to be symmetric about the central axis; a plurality of first conducting bars, each being inserted into respective one of the plurality of slots, being disposed to be in close contact with an inner wall of the slot in a direction of the through hole, and having a protrusion that may protrude outwards from the rotor core when being inserted into the slot; a fastening member arranged to enclose protrusions of the plurality of first conducting bars to fix the plurality of first conducting bars; and a plurality of second conducting bars, each being disposed in respective one of the plurality of slots into which corresponding one of the plurality of first conducting bars is inserted.

According to the present disclosure, the slots are formed in the rotor core and stably provided with the first conducting bar and the second conducting bar of different materials. After the first conducting bar is fixed in the slot by use of the fastening member, the second conducting bar is formed stably by the die casting.

Since the second conducting bar is formed stably, the rotor of the hybrid induction motor according to the present disclosure can homogenize the quality of the motors and at the same time improve the efficiency of the hybrid induction motor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a simplified longitudinal cross-sectional view of an electric motor according to an exemplary embodiment of the present disclosure;

FIG. 2 is a perspective view of a top portion of a stator according to an exemplary embodiment of the present disclosure;

FIG. 3 is a perspective view of a top portion of a first conducting bar according to an exemplary embodiment of the present disclosure;

FIG. 4 is a bottom perspective view of a portion of a stator, seen from an exterior lower direction, according to another exemplary embodiment of the present disclosure;

FIG. 5 is a perspective view of a top portion of a first conducting bar according to another exemplary embodiment of the present disclosure; and

FIG. 6 illustrates a method of fixing the first conducting bar according to another embodiment of the present disclosure.

The drawings described herein are for illustration purposes only and are not intended to limit the scope of the present disclosure in any way.

### DETAILED DESCRIPTION

In the following description and the accompanied drawings, only parts necessary for understanding embodiments of the present disclosure will be described, and detailed descriptions of well-known functions or configuration that may obscure the subject matter of the present disclosure will be omitted for simplicity.

The words “top”, “bottom”, “upper”, “lower”, “upwards”, “downwards”, and the like are used to herein to mean directions defined by the drawings, but the shape and the location of the component is not limited by the words.

The terms and words used in the following description and appended claims are not necessarily to be construed in an ordinary sense or a dictionary meaning, and may be appropriately defined herein to be used as terms for describing the present disclosure in the best way possible. Such terms and words should be construed as meaning and concept consistent with the technical idea of the present disclosure. The embodiments described in this specification and the configurations shown in the drawings are merely preferred embodiments of the present disclosure are not intended to limit the technical idea of the present disclosure. Therefore, it should be understood that there may exist various equivalents and modifications which may substitute the exemplary embodiments at the time of filing of the present application.

Hereinbelow, an exemplary embodiment of the present disclosure will be described in detail with reference to the accompanied drawings.

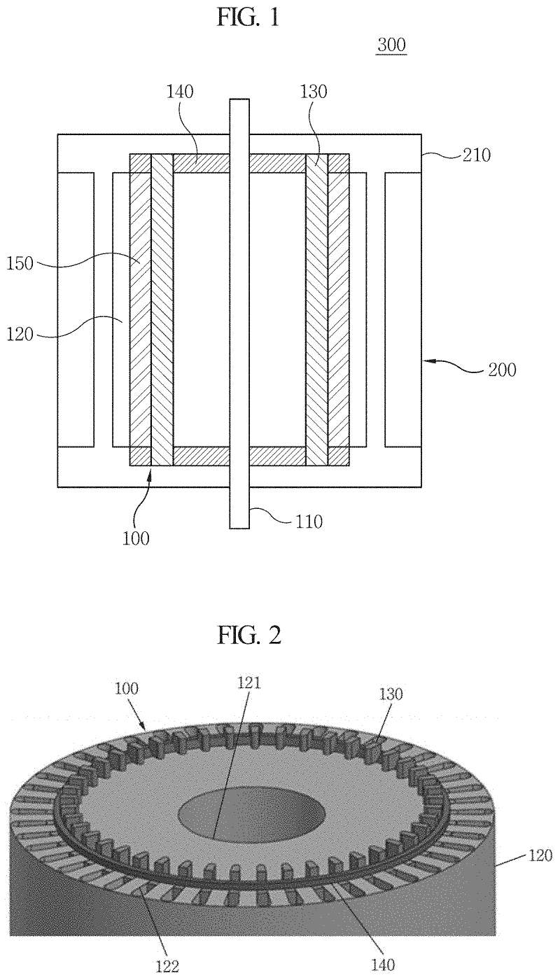

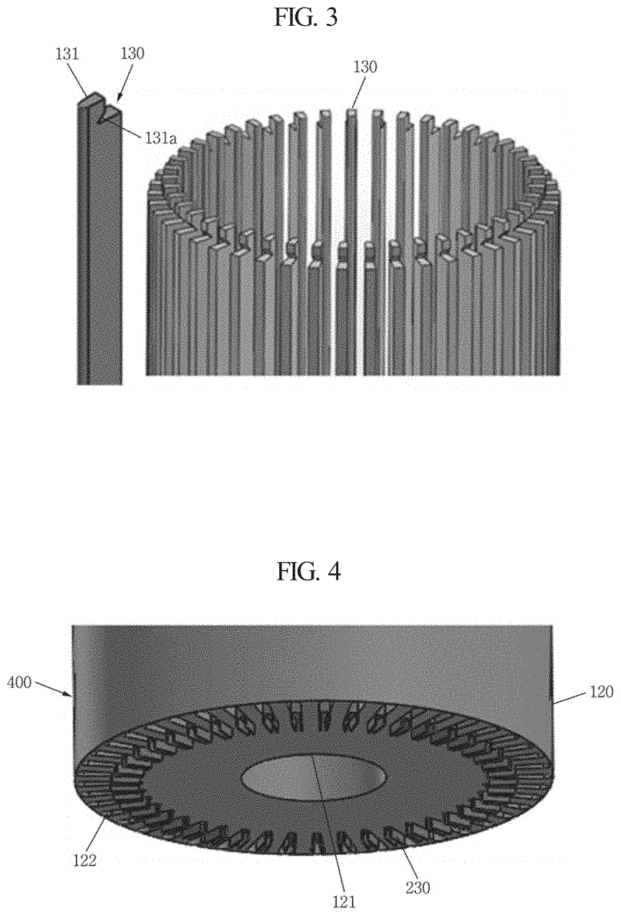

FIG. 1 is a simplified longitudinal cross-sectional view of an electric motor according to an exemplary embodiment of the present disclosure, FIG. 2 is a perspective view of a top portion of a stator according to an exemplary embodiment of the present disclosure, and FIG. 3 is a perspective view of a top portion of a first conducting bar according to an exemplary embodiment of the present disclosure.

Referring to FIGS. 1 to 3, a motor 300 according to an exemplary embodiment of the present disclosure includes a rotor 100, a stator 200, and a casing 210.

The stator 200 may be fixedly installed inside an inner surface of the casing 210 and may have a cylindrical shape forming a central cavity to accommodate the rotor 200. The stator 200 may be formed with a plurality of poles protruding inwards from its inner surface. A coil may be wound at each pole of the stator 200 to wrap the pole through the space between the poles.

The stator 200 may be formed using a plurality of laminated electrical steel. However, the present disclosure is not limited thereto, and the stator 200 may be made from soft magnetic composites (SMC).

The rotor 100 may be accommodated in the central cavity of the stator 200 and be spaced apart from the stator 200 by a predetermined spacing to form a gap between the rotor 100 and the stator 200. The rotor 100 may include a rotation shaft 10, a rotor core 120, a first conducting bar 130, a fastening member 140, and a second conducting bar 150. The rotation shaft 110 is rotatably coupled to the casing 210 and is fixedly coupled to the rotor core 120 to rotate with the rotor core 120 according to a magnetic flux formed between the stator 200 and the rotor core 120.

The rotor core 120 forms magnetic paths through which magnetic flux generated by windings in the stator 200 can pass. The rotor core 120 may be formed in a cylindrical shape having a through hole 121 in its central axis and into which the rotation shaft 110 can be inserted. The rotor core 120 may be formed of a plurality of laminated steel. However, the present disclosure is not limited thereto, and the rotor core 120 may be made from soft magnetic powder.

When an alternating current is applied to the windings of the stator 200, an electric current is generated in the rotor core 120 by an electromagnetic induction from a magnetic field of the windings in the stator 200. Further, a torque is produced in the rotor 120 by an interaction between the current induced in the rotor core 120 and the magnetic flux generated by the stator windings, and the rotor 120 rotates together with the rotation shaft 110.

The rotor core 120 may be formed with a plurality of slots 122 extending axially and penetrating an upper surface and a lower surface of the rotor core 120. In a longitudinal cross section, the plurality of slots 122 may be disposed radially to be symmetric about the through hole 121. The plurality of slots 122 accommodate the first conducting bar 130 and the second conducting bar 150, which is described below.

Each of the plurality of slots 122 may have a rectangular or filleted rectangular cross-sectional shape as shown in the drawing. However, the present disclosure is not limited thereto. For example, a portion in which the first conducting bar 130 is inserted and another portion in which the second conducting bar 150 is inserted may be divided separately, so that the first conducting bars 130 and the second conducting bars 150 inserted into the plurality of slots 122 finally forms dual squirrel cages.

The first conducting bar 130 which is inserted into each of the plurality of slots 122 may be disposed to be in close contact with an inner wall of the slot in a direction of the through hole 121. The first conducting bar 130 may be formed with a first protrusion 131 that may protrude outwards from at least one of a top surface and a bottom surface of the rotor core 120. The first conducting bar 130 may be formed of a material containing copper that has a relatively higher conductivity than aluminum.

The first protrusion 131 may allow a fastener receiving recess 131a to be formed on an outer surface of the first protrusion 131. The fastener receiving recess 131a provides a space for accommodating the fastening member 140 having a ring shape or a wire shape as described below. Preferably, the fastener receiving recess 131a may be formed in a shape corresponding to an inner portion of the fastening member 140 in order to prevent a migration of the fastening member 140 in an assembled state.

The fastening member 140 may be arranged to enclose the first protrusions 131 of the plurality of first conducting bars 130 and secure the plurality of first conducting bars 130. The fastening member 140 may be formed in the ring shape or the wire shape. Also, the fastening member 140 may be formed of a metallic material such as iron, copper, and aluminum.

When the fastening member 140 is fully engaged with the fastener receiving recesses 131a of the plurality of first conducting bars 130, the plurality of first conducting bars 130 are aligned to be in close contact with the inner wall of respective slots in the direction of the through hole 121.

The second conducting bar 150 is disposed inside the slot 122 into which the first conducting bar 130 is inserted. The second conducting bar 150 may be formed through a die casting in the remaining space of the slot 122 where the first conducting bar 130 is inserted. The second conducting bar 150 may be formed of a material including aluminum. That is, after the first conducting bars 130 are fixed by the fastening member 140, the second conducting bars 150 may be formed in the plurality of slots 122 by filling molten metallic material such as aluminum in the remaining space of the plurality of slots 122.

As described above, the rotor 100 of the hybrid induction motor 300 according to an exemplary embodiment of the present disclosure is formed with a plurality of slots 122, and the first conducting bar 130 and the second conducting bar 150 made of different materials are arranged in each of the slots. The second conducting bar 150 may be formed stably through the die casting after the first conducting bar 130 is fixed by the fastening member 140.

Since the second conducting bar 150 in the rotor 100 of the hybrid induction motor 300 according to the present disclosure can be formed stably, it is possible to make the quality of the motor products uniform and improve the efficiency of the motor.

Hereinbelow, the rotor 400 according to another embodiment of the present disclosure will be described with reference to FIGS. 4-6.

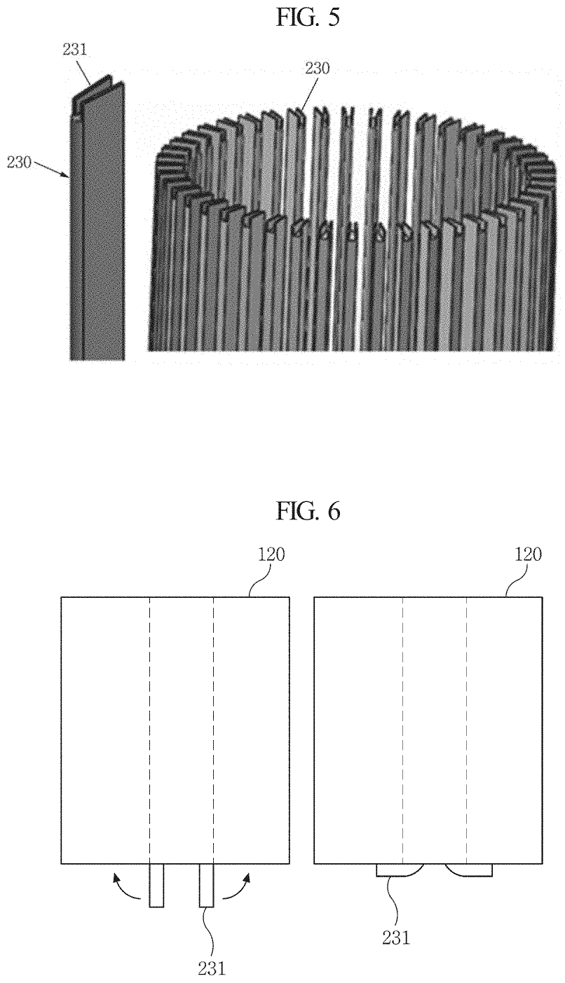

FIG. 4 is a bottom perspective view of a portion of the stator, seen from an exterior lower direction, according to another exemplary embodiment of the present disclosure, FIG. 5 is a perspective view of a top portion of the first conducting bar according to another exemplary embodiment of the present disclosure, and FIG. 6 illustrates a method of fixing the first conducting bar according to another embodiment of the present disclosure.

The rotor 400 according to the embodiment shown in FIGS. 4-6 has substantially the same configuration as the rotor 100 according to the embodiment shown in FIGS. 1-3 except for the shape of the protrusion 131 of the first conducting bar 130. Therefore, the same reference numerals will be designated for the same configurations in FIGS. 4-6, and duplicate descriptions will be omitted for simplicity.

The first conducting bar 230 of the rotor 400 according to another embodiment of the present disclosure may be formed with a second protrusion 231 that may protrude outwards from a top surface or a bottom surface of the rotor core 120.

For each of the first conducting bars 230, the second protrusion 231 may be provided in a pair. For example, the second protrusion 231 may be divided into a pair of plate members facing each other, and may be fixed to be close to the top surface or the bottom surface of the rotor core 120 by an external force.

In other words, the second protrusion 231 may look like a rivet tail, and an assembly technician may fix the first conducting bar 230 to the rotor core 120 by tapping the second protrusion 231 by a hammer or another tool to flex the second protrusion 231 so that the second protrusion 231 is in close contact with the surface of the rotor core 120.

On the other hand, according to yet another exemplary embodiment of the present disclosure, the rotor 400 may include a first protrusion 131 which is provided on one of the top surface or the bottom surface of the rotor core 120 and formed with a fastener receiving recess similar to the embodiment shown in FIGS. 1-3, and a second protrusion 231 which is provided on the other one of the top surface and the bottom surface of the rotor core 120 and can be tightly fixed to the rotor core 120 like a rivet by an external force similar to the embodiment shown in FIGS. 4-6.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made therein without departing from the spirit and scope as defined by the following claims.

What is claimed is:

1. A rotor of a hybrid induction motor, comprising:
a rotation shaft;
a rotor core having a through hole formed along a central axis and having a plurality of slots formed to penetrate the rotor core between a top surface and a bottom surface and arranged radially to be symmetric about the central axis;
a plurality of first conducting bars, each being inserted into respective one of the plurality of slots, being disposed to be in close contact with an inner wall of the slot in a direction of the through hole, and having a protrusion that may protrude outwards from the rotor core when being inserted into the slot;
a fastening member arranged to enclose protrusions of the plurality of first conducting bars to fix the plurality of first conducting bars; and
a plurality of second conducting bars, each being disposed in respective one of the plurality of slots into which corresponding one of the plurality of first conducting bars is inserted.

2. The rotor of claim 1, wherein the fastening member has a shape of a ring or a wire.

3. The rotor of claim 2, wherein the protrusion has a fastener receiving recess formed on its outer surface.

4. The rotor of claim 3, wherein the fastening member is inserted into the fastener receiving recess to fix the plurality of first conducting bars.

5. The rotor of claim 1, wherein the plurality of second conducting bars are formed through a die casting in remaining spaces of the plurality of slots after the plurality of first conducting bars are inserted.

6. The rotor of claim 1, wherein the protrusion comprises:
a first protrusion protruding upwards from the rotor core; and
a second protrusion protruding downwards from the rotor core.

7. The rotor of claim 6, wherein the second protrusion is provided in a pair and is fixed to be close to a top surface or a bottom surface the rotor core by an external force.

8. A hybrid induction motor, comprising:
a rotor; and
a stator disposed to be spaced apart from the rotor by a predetermined distance;
wherein the rotor comprises:
a rotation shaft;
a rotor core having a through hole formed along a central axis and having a plurality of slots formed to penetrate the rotor core between a top surface and a bottom surface and arranged radially to be symmetric about the central axis;
a plurality of first conducting bars, each being inserted into respective one of the plurality of slots, being disposed to be in close contact with an inner wall of the slot in a direction of the through hole, and having a protrusion that may protrude outwards from the rotor core when being inserted into the slot;
a fastening member arranged to enclose protrusions of the plurality of first conducting bars to fix the plurality of first conducting bars; and
a plurality of second conducting bars, each being disposed in respective one of the plurality of slots into which corresponding one of the plurality of first conducting bars is inserted.
